(19) United States
(12) Patent Application Publication
(10) Pub. No.: US 2010/0301273 A1
(43) Pub. Date: Dec. 2, 2010

(54) BIOMASS GASIFICATION METHOD AND APPARATUS FOR PRODUCTION OF SYNGAS WITH A RICH HYDROGEN CONTENT

(76) Inventors: Wlodzimierz Blasiak, Saltsjo-Duvnas (SE); Weihong Yang, Taby (SE)

Correspondence Address: Lynn E Barber, P O Box 16528, Fort Worth, TX, 76162, US

(21) Appl. No.: 12/735,336

(22) PCT Filed: Jan. 14, 2009
(86) PCT No.: PCT/SE2009/050019

§ 371 Date: Aug. 6, 2010

Related U.S. Application Data
(60) Provisional application No. 61/011,031, filed on Jan. 14, 2008.

(51) Int. Cl. C01B 3/02; B01J 19/00

(52) U.S. Cl. 252/373; 422/198

(57) ABSTRACT

A biomass gasification method and apparatus for production of syngas with arich hydrogen content. In the gasification process the gasification energy is supplied by the sensible heat carried by a high temperature agent combined with the heat released by the chemical reaction between calicined lime and carbon dioxide.

### CROSS-REFERENCE TO RELATED APPLICATIONS

This application claims priority from PCT/SE2009/050019 filed Jan. 14, 2009, which claims priority from U.S. Provisional Patent Application Ser. No. 61/011,031, filed Jan. 14, 2008.

### BACKGROUND OF THE INVENTION

This invention relates to thermal gasification processes and in particular to biomass gasification processes. Thermal gasification is the process of converting carbonaceous materials, such as coal, petroleum coke, biomass, and/or solid waste etc. into combustible gases. The combustible gases are primarily hydrogen and carbon monoxide mixed with lesser amounts of carbon dioxide, water, methane, higher hydrocarbons, and nitrogen. Air, steam, and oxygen, either alone or in any combination thereof, are often used as gasification agents. Using pure steam as gasification medium is very attractive since the caloric value of produced syngas can be much higher due to no dilution by N₂ and CO₂. The syngas also has higher hydrogen content. Generally, factors that affect the performance of the thermal gasification reactor system include: stoichiometry of reactants, gasification temperature and pressure, heating rate of feedstock, kind of gasifying agents, residence time, feedstock properties, and catalyst or bed additives.

The thermal gasification processes are highly endothermic chemical reactions. The general methods for supplying heat for the gasification include: a) an outside source, e.g. hot char recirculation, and/or sensible heat from a gasification agent, b) reaction heat from oxidization of a part of feedstock (incoming carbonaceous materials), and c) exothermical reaction heat from a non-carbonaceous material such as calcined lime and CO₂.

The application of the technology of partial combustion of incoming carbonaceous materials is widely adopted. By the technology, the non combustible gas, CO₂, is produced and as it is not removed it leads to a diluted syngas, and the LCV (low caloric value, a measure for the burning value of the dry gas mass) of the produced syngas becomes limited. Moreover, the existing CO₂ leads to a small partial pressure of other gas species, which is not favorable for other valuable gasification reactions, for example, the water-gas shift reaction. Thus, the hydrogen content in the syngas will be affected.

The idea of supplementing most of the energy using sensible heat for the gasification process has recently been considered, and positive results have been shown. For example, the invention of Yoshikawa, Kunio (Sagamihara-shi, JP) and Suzuki, Narumi (Tajimi-shi, JP) of US 2004/0060236, “Apparatus for gasifying solid fuel”, teaches an economic small scale gasification system for gasifying solid fuel into pyrolysis gas in which heated steam/air is introduced into a reformer along with the pyrolysed gas producing reformed high temperature crude gas. Here, high temperature steam/air will be obtained mainly by use of a honeycomb regenerative heat exchanger explained in, for example, U.S. Pat. No. 6,837,910. The temperature of hot gasifying medium cannot be over 1600K (1323° C.). If pure steam is used for the gasification process using the regenerative heat exchanger, the temperature of the steam will be at the level of 700-1250° C. Thus, the quantities of H₂ and CO produced per unit of steam are very low. This leads to an uneconomic gasification.

Other known systems using high-temperature air/steam/oxygen as high as 1000° C. for a biomass/waste gasification process have also been applied (Lucas C., Szewczyk D., Blasiak W., Mochida S., High Temperature Air and Steam Gasification of Densified Biofuels, Biomass and Bioenergy, Volume 27, Issue 6, December 2004, Pages 563-575). A char free hydrogen rich gas, where the process is performed with only steam at a temperature of 1000° C. and at a conventional pressure of about 1 atm has been proposed (Ponzio Anna, Yang Weihong,. Lucas, C, Blasiak W., Development of a Thermal Homogenous Gasifier System using High Temperature Agent, CLEAN AIR—International Journal on Energy for a Clean Environment., Vol. 7, No. 4., 2007).

Further development of using high-temperature agents for gasification process, i.e. pure steam for gasification, is described in for example US 2003/0233788, of Lewis, Frederick Michael (El Segundo, Calif.) “Generation of an ultra-superheated steam composition and gasification therewith”, where a new method using the sensible heat of the steam is proposed. It is a method for gasifying carbonaceous materials into fuel gases. It involves the formation of an ultra-superheated steam (USS) composition substantially containing water vapor, carbon dioxide and highly reactive free radicals thereof, at a high temperature 2000° F. (1316° C.) to about 5000° F. (2760° C.). The USS flame is contacted with a carbonaceous material for rapid gasification/reforming thereof. In addition, a controlled amount of oxygen for oxidation of fuel for heating the steam has to be used, increasing the operation cost. Additionally, when the pure steam temperature is less than 2075K (1802° C.), a surplus of steam is still required to convert all the carbon. Moreover, the carbon conversion rate is also low. All these restrictions may make the process uneconomical, especially for the small scale gasifier system.

It is well known that using pure steam as a gasification medium can increase syngas quality. However, the gasification process using pure steam is extremely endothermic. If all the gasification energy is supplied by the sensible energy carried by the gasification agent, the temperature of gas has to be very high. For example, if we consider the gasification reaction between carbon and steam, the steam temperature is at least 2075K (1802° C.) in order to have a theoretical stoichiometric ratio. Thus, at lower temperatures either a long residence time or a larger amount of excess steam is required. This leads to low process efficiency and corresponding high economic costs. For example, when even a modern regenerative heat exchanger is used as in U.S. Pat. No. 6,837,910, assigned to Japan Science and Technology Agency, the temperature of the steam is at the level of 700-1250° C. Considering the wall/pipe/system heat loss that will be obtained in an embodiment of the technology, larger quantities of excess and not reacted steam have to be used.

It is important to notice, that with a steam temperature increase, the hydrogen concentration in the produced gas is decreased since the water-shift reaction is an exothermal reaction. In this case, a lower ratio of H₂:CO in the generated gas occurs.

Moreover, in order to obtain medium and high LCV of syngas using pure steam as agent, where the carbon conversion ratio of biomass is normally 70-80%, a reasonable high flow rate of the steam has to be used even though the temperature of the steam is high. Thus, the yields of syngas may be further increased by also applying a high flow rate of the steam.

Described in the herein disclosed invention is a novel process drastically improving the above described gasification technologies. Instead of obtaining the extra heat by partial combustion of incoming carbonaceous materials the herein described invention supplies extra heating using reaction heat from non-carbonaceous materials such as calcined lime and CO₂. This is done in order to increase the hydrogen concentrations in the syngas and the thermal conversion ratio of the feedstock.

In the disclosed invention, the high-temperature air/steam can be obtained using either a modern regenerative heat exchanger (U.S. Pat. No. 6,837,910), or the technical methods described herein.

Using reacting heat from e.g. calcined lime and CO₂ has been tested widely. An example using the heat from the reaction between CaO and CO₂ supplied by oxidation of a part of the solid fuel is published in U.S. Pat. No. 4,191,540. In this case, CaO particles are generally used as the gasifier bed materials to induce an on-site CO₂ capture via

CaO+CO₂=>CaCO₃exothermic reaction −42.5 kcal

Thus, the syngas has a low CO₂ content and a high caloric value. In a calciner coupled to the gasifier, the formed CaCO₃ was regenerated into CaO and reused through recirculation. Since the above equation is a volume-reducing reaction, high pressure was commonly used. Additionally, reasonable low reaction temperatures are needed to prevent the CaCO₃ calcination, i.e.

CaCO₃->CaO+CO₂

Because of these facts the gasification process using Ca-based material is operated generally at 1000-1100 K and >=20 atm to produce a high caloric pipeline gas from coal or coal coke. In U.S. Pat. No. 4,191,540) a fluidized bed reactor is used. The gasification reaction heat needed is only supported by the carbonate reaction and partial oxidization of solid fuel. High-temperature steam over 1000 K is not used or taught. The process was further investigated and improved by elevating the pressure up to >30 atm and a relatively low temperature steam (about 873K) integrating the carbon fixation and the gasification process in the so-called Hy-Pr-RING process (U.S. Pat. No. 7,014,834 B2).

A paper by Lin et al., Energy Conversion and Management, 43, (2002), 1283-1290 discusses the above Hy-Pr-RING process where the chemical reactions are integrated into one reactor. The process was first developed on coal, but later on developed to run entirely on water and a carbon fuel. It was shown that low temperatures (below 900° C.) at high pressures using steam resulted in 90% hydrogen gas; also on organic waste.

If CaO is added in a sufficient amount in order to absorb all the formed CO₂ the pressure should be at least 220 atm and the temperature not lower than 600° C. As this is not realistic to achieve at a reasonable cost of equipment and operational safety another solution has to be provided. This is stated in U.S. Pat. No. 7,014,834 B2.

From all of the above known prior art, it can be seen that the main gasification reaction heat is supported by the fixation of CO₂ by CaO combined with partial oxidization of solid fuel, i.e. not by using the sensible heat of high temperature steam. Additionally, a relative higher pressure is needed in order to achieve a reasonable CO₂ capture.

In the herein disclosed invention biomass gasification with high temperature steam/air gasification agents and Ca-Based CO₂ sorbents at atmospheric pressure are used and the gasification process temperature is around 1000K. High-temperature steam is not only acting as a gasification agent, but also acting as an energy supplement.

Moreover, gasification invariably results in the formation of three major classes of products: a) a mixture of gases (H₂, CO, CO₂, CH₄ and N₂ and small part of big molecular hydrocarbons), b) tar, and 3) solid residues. The fuel gases have to be cleaned for use in internal combustion engines, gas turbines or other applications requiring high-quality gas. Generally, the tar and solid residues from the gasifiers available on the market today do not meet acceptable values when operated without gas cleaning.

Typical values to be achieved for use in gas turbines are: particulates <1 ppm, tar <5 mg/m³, HCL <0.5 ppm, S(H₂S+SO₂ etc.) at the level of 1 ppm, Na <1 ppm, K<1 ppm, and other metals <1 ppm (Bridgwater, A. V., Beenackers A. A. C. M., Sipila, K., Zhenhong, Y., Chuangzhi W. and Li S., An assessment of the possibilities for transfer of european biomass gasification technology to China). For gas engines, maximum allowable concentration of particulates is <50 mg/m³, and tar <100 mg/m³. Turbocharged engines make an even higher demand on gas quality and in order to avoid fouling and deposits in the engine, the gas should be to a large degree tar- and dust-free (Bridgwater, A. V. and Evans G. D., An assessment of thermochemical conversion systems for processing biomass and refuse, Energy Technology Support Unit (ETSU) on behalf of the Department of Trade, ETSU B/T1/00207/REP, 1993).

Gas cleaning can be achieved by two basic gas treatment methods: hot gas filtration and wet gas scrubbing. It is obvious that direct treatment of the hot syngas from the gasifier gives the highest process efficiencies.

In order to perform the hot gas cleaning or hot gas conditioning, generally, a catalyst is used for this reforming process. However, in order to avoid poisoning and fouling of a catalyst, high temperature syngas has to been cleaned (tar removal, other elements, mainly S and HCl) and cooled; for example, as in patent US 2004/0060236. In such a type of gasification system, the thermal efficiency of the whole system is low. In order to prevent such a heat loss, the steam reforming process is considered to be employed, in which steam is mixed with the thermal decomposed gas so as to reform the hydrocarbon in the thermal decomposed gas by means of a steam reforming reaction as done in U.S. Pat. No. 6,837,910 B1. Another way is to let the thermal decomposed gas pass through a bed packed with CaO-based particles, for example, as by Delgado J., Aznar M. P., and Corella. J., Biomass gasification with steam in fluidized bed: effectiveness of CaO, MgO, and CaO—MgO for hot gas cleaning, Ind Eng. Chem., Res, 1997, 36, 1535-1543.

In the first case, since only high-temperature steam is injected into the reformer in an amount for enough reactant to be present, the sensible heat from this high-temperature steam is not enough to satisfy the energy need for the steam reforming process. Extra heat or air/oxygen has to be injected into the reformer. This consumes syngas. For the second method by Delgado J., Aznar M. P., and Corella. J., Biomass gasification with steam in fluidized bed: effectiveness of CaO, MgO, and CaO—MgO for hot gas cleaning, Ind Eng. Chem., Res, 1997, 36, 1535-1543, CaO-based material is only added in order to work as a catalyst for the oxidation of CO and tar reforming/cracking.

In the disclosed invention, a hot gas clean/conditioning is proposed. The unique method of promoting steam reforming and water-shift reactions through increasing steam partial pressure by injection high-temperature steam to as high as 1000 K, and decreasing CO₂ partial pressure by CO₂ absorption by CaO is neither taught nor disclosed in any of the above discussed prior art.

Thus, the object of the present invention is to provide a thermal gasification method and an apparatus for production of syngas with a medium or high LCV (lower caloric value), rich in hydrogen and with only minor amounts of char, tar, and other particulates.

Another object of the present invention is to provide a thermal gasification process and an apparatus in which a maximal quantity of usable syngas per unit of steam introduced into the gasifier is produced

Another object of the present invention is to provide a thermal gasification process and an apparatus, in which a maximal quantity of usable syngas rich in hydrogen per unit of CaO introduced into the gasifier is generated.

Another object is to provide a method and an apparatus in which a maximal quantity of hydrogen gas per unit of steam, and/or per unit of calcined lime consumed is produced. The relative importance of these two parameters is optimized with respect to the overall economy.

Another object of the present invention is the use of an apparatus to generate a high temperature gasification agent (steam/air/oxygen) of a temperature in the range of 800 to 1600° C. for the proposed thermal gasification.

Another object is to provide a method for controlling a thermal gasification process for gasification at conditions optimal with respect to raw materials consumption, yield, the ratio of H₂:CO of final product, and cost.

Other objects and advantages of the present invention will become obvious to the reader and it is intended that these objects and advantages are within the scope of the present invention.

### SUMMARY OF THE INVENTION

The invention herein relates to a method and apparatus for gasifying carbonaceous materials. More particularly, the invention relates to a method and apparatus for generating a high quality syngas rich in hydrogen by gasifying solid fuel or solid carbonaceous materials, such as biomass by a thermal conversion process.

The disclosed invention provides a gasification process whereby the gasification energy is supplied by the sensible heat carried by the high temperature agent (even pure steam) as high as 1000 K combined with the heat released by the chemical reaction between calcined lime and carbon dioxide.

It is found that a gasification system comprising a high temperature steam/air/oxygen gasifier including adding CO₂ directly into the gasifier, or including a syngas reformer, together with a CO₂ recovery system, can form an efficient gasification system for gasification of solid fuel such as biomass. The system comprises a gasification step using high temperature steam in excess to supply the required extra heat in a first reactor for production of syngas, and either adding CaO together or separately from the water/steam to the gasifier in a first embodiment, or to a refining process of the produced syngas for capturing the formed carbon dioxide in a second reactor in a second embodiment, followed by separation of the hydrogen gas from particulates in a separator, and recovering of the absorbent by a heating step. These processes turned out to have a satisfactory efficiency regarding moles of steam used per moles of hydrogen produced, and a medium and high LCV value for the hydrogen gas.

The required heat of the process according to the present invention is provided by the sensible heat of the hot steam and the heat of the reaction between CaO and CO₂. In the present invention CaO is provided at normal grade.

The process according to the present invention does not require high pressures. In the first embodiment of the invention, the pressure of a first reactor, a gasifier, is working at 1 atm and in the temperature range from 600 to 900° C.

In the second embodiment of the invention the pressure of a first reactor, a gasifier is working at 1 atm and in the temperature range from 800 to 1600° C. The syngas from the gasifier enters a second refining reactor. The pressure of this second reactor is 1 atm and the temperature from 600 to 900° C.

Preferably, a ratio of steam to carbon source is in the range of 1.6:1 or higher is used.

### BRIEF DESCRIPTION OF THE DRAWINGS

FIG. 1 is a generalized flow diagram illustrating a preferred arrangement of the first type of embodiment of a solid fuel gasifying apparatus according to the invention.

FIG. 2 is a general side view of a heat exchanger to heat low temperature gases (steam/air/oxygen) up to 1000° C. using a ball type regenerator which is representative of the heat exchanger useful in the practice of the invention.

FIG. 3 is a general side view of another type of heat exchanger to heat low temperature gases (steam/air/oxygen) up to 1300° C. using a rotary honeycomb type regenerator, which is representatives of the heat exchanger useful in the practice of the invention.

FIG. 4 is a general side view of another type of high temperature gasification agent generator using a very lean catalytic combustor regenerator which is representative of the heat exchanger useful in the practice of the invention.

FIG. 5 is a general block flow diagram of the gasifying facility as shown in FIG. 1.

FIG. 6 is a generalized block flow diagram illustrating a modification of the gasifying facility as shown in FIG. 1.

FIG. 7 is a generalized block diagram of an exemplary gasification process according to an embodiment of the invention in FIG. 6.

FIG. 8 is a generalized block diagram of an exemplary gasification process according to an embodiment of the invention in FIG. 5.

FIG. 9 is a generalized block diagram of an exemplary gasification process according to the invention.

FIG. 10 shows gasifier structure and temperature measurement points.

FIG. 11 shows LHV of product gas as a function of operational parameters.

FIG. 12 shows concentrations of tar species in product gas.

### DETAILED DESCRIPTION OF THE INVENTION AND PREFERRED EMBODIMENTS THEREOF

The invention herein is a method and apparatus for gasifying a solid material. The method comprises: a) providing at least one high heat source to supply energy for gasification in a gasifier containing the solid material, resulting in gases including CO₂ and hydrogen gas, and particulates, the heat source provided by a method selected from the group consisting of: i) feeding a high temperature gasifying agent in excess to supply required extra heat into the gasifier; and ii) utilizing a Ca-based CO₂ absorbent to supply exothermic reaction heat; b) separating hydrogen gas from the particulates in a separator; and c) recovering the Ca-based CO₂ absorbent by a heating step, wherein the gasifier is at atmospheric pressure, and wherein complete combustion is increased in the gasifier. The solid material is preferably selected from the group consisting of coal, petroleum coke, biomass, and solid waste.

The preferred Ca-based CO₂ absorbent is CaO, which is added to the gasifier together with the solid material and the high temperature gasifying agent, and the gasifier is at 600-900° C. The preferred high temperature gasifying agent is selected from the group consisting of steam, air and oxygen and combinations thereof. When the high temperature gasifying agent is pure steam, a single gasification reactor is preferably used to produce a high level of hydrogen gas. When the high temperature gasifying agent is a mixture of components selected from the group consisting of steam, air and oxygen, the gasification preferably utilizes two reactors, a first reactor to thermally decompose solid fuel to produce gases, solid materials and excess steam, and a second reactor to produce a hydrogen-rich gas.

The gasification facility of the invention preferably comprises: 1) a high temperature gasifying agent generator 18, 2) a gasification apparatus-comprising a) a gasifier 24, b) a solid gas separator 26, and c) a combustor for regeneration of sorbent 27. The high temperature gasifying agent generator 18 may comprise at least one of: a heat exchanger 21, a combustor 23 and a mixer 22, to generate a high temperature gas 19 or 20 with a temperature in the range of 800 to 1600° C.

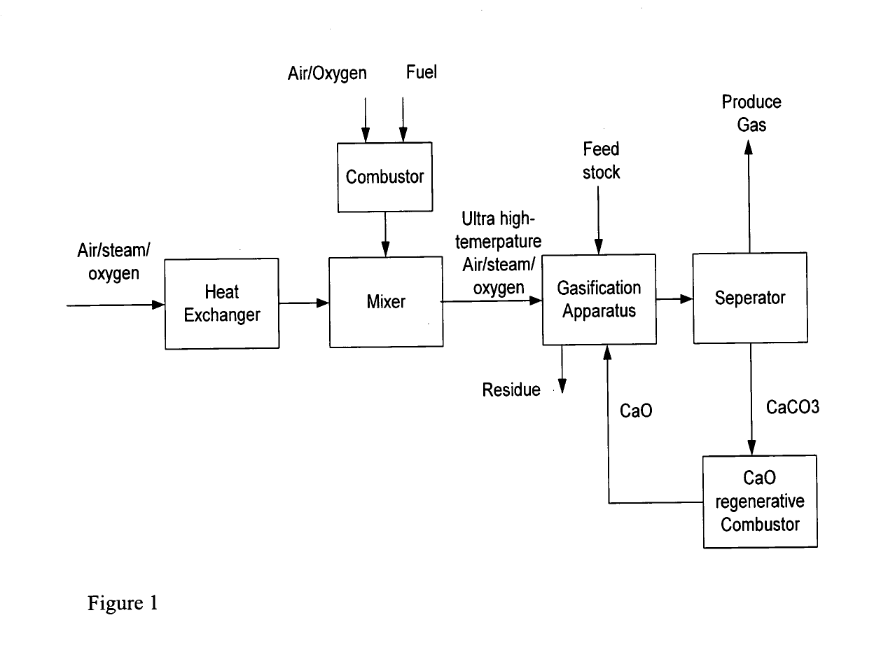

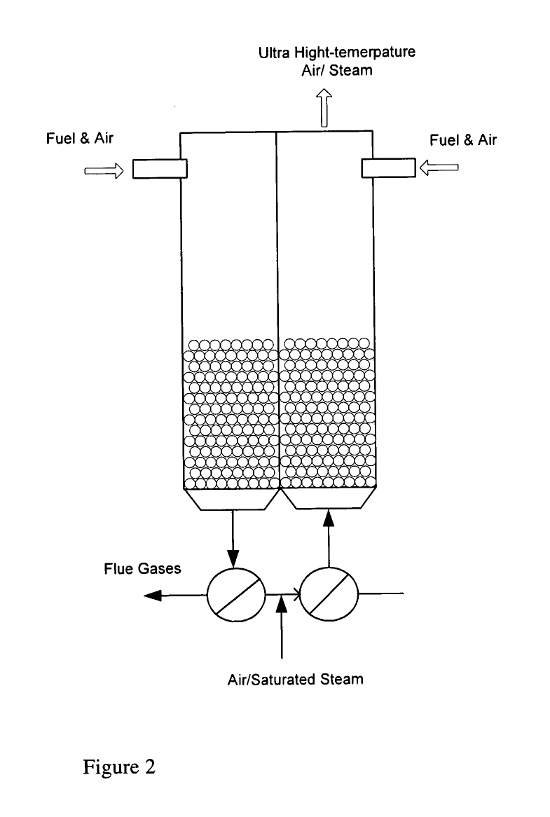

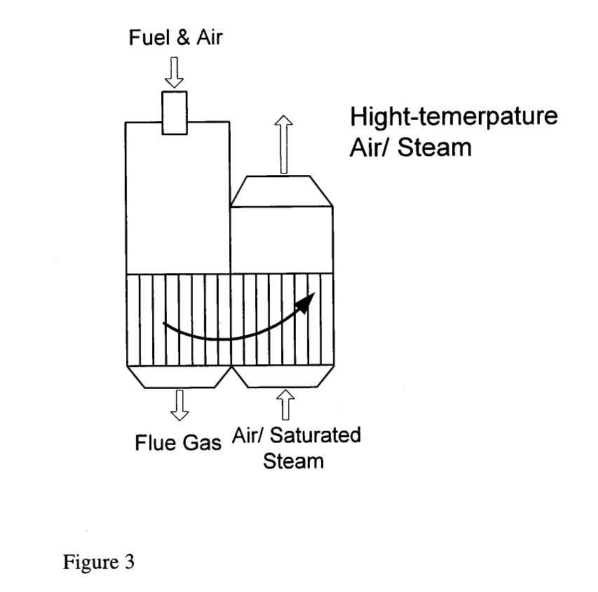

As discussed in more detail below, the disclosed invention herein is thus a biomass 2 gasification system where high temperature steam/air is used as gasification agent in a first reactor, up-draft reactor, comprising a gasifer 24 and sometimes even a reformer 25, for production of a syngas 10. Optionally, the steam can contain a little amount of air/oxygen. Using no air, an almost N₂ free hydrogen gas is obtained. A high temperature is used as this favors the formation of hydrogen, FIG. 1. The heat for the endothermic processes is supposed to be provided by the hot steam 19 comprising pure steam and optionally additional agents 20. For heating the hot steam and/or other agents either a gasifying agent generator 18 such as a honey-comb heat regenerator (FIG. 3) or a ball heat exchanger, (FIG. 2) is used.

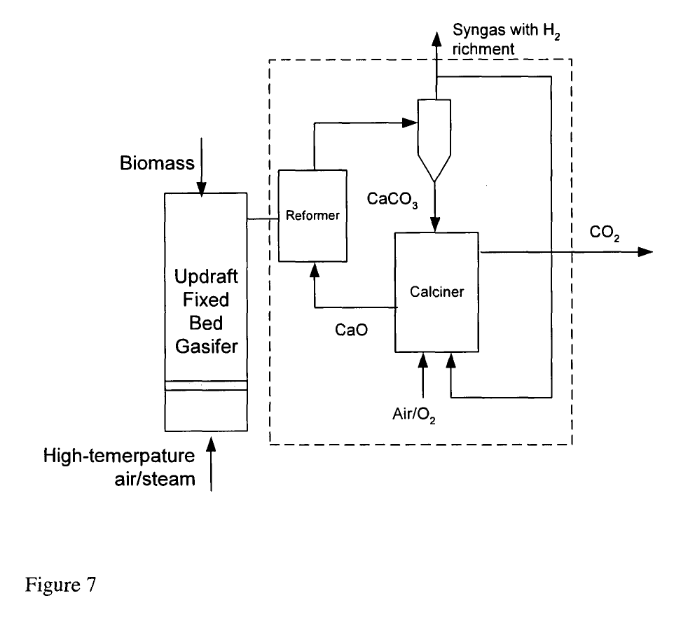

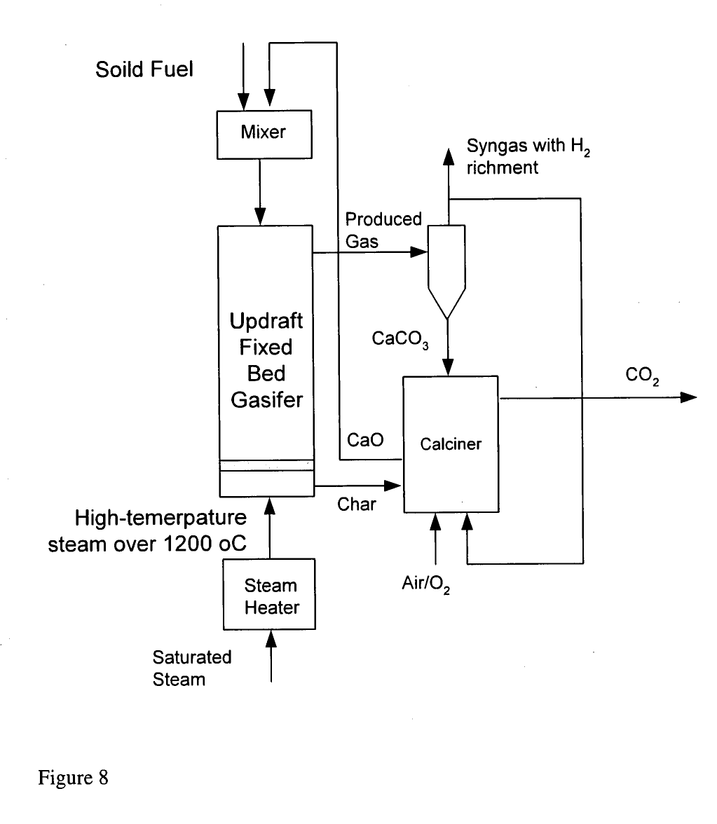

The produced syngas 10 may enter a second reactor, a fluidised bed 25, together with CaO 14 from a calciner 27. Alternatively CaO 14 is added to the gasifier or updraft reactor 24, e.g. as shown in FIG. 8. CaCO₃ 15 is produced as particles among the syngas10 in the fluidised bed 25/gasifier 24. Steam can optionally be added to the fluidised bed to convert remaining CO into CO₂ and hydrogen. The syngas 10 containing CaCO₃ particles is let into a cyclone 26 where CaCO₃ 15 drops out into a calciner 27, where CaO 14 is regenerated and CO₂ 12 collected (FIG. 7). The temperature in the gasifier 24 is above 1000° C. (1273K) and in the fluidised bed 25 around 650° C. (923K).

The total system of the present invention comprises two major parts: firstly a high temperature steam/air/oxygen generator 18, and secondly a gasification apparatus 1. (See FIG. 1)

The high temperature steam/air/oxygen generator 18 can comprise:
A heat exchanger 21, or
A combustor 23 or
A mixer 22
   either alone or any combination of them. The aim is generating a high temperature gas 19 or 20 with a temperature in the range of 800 to 1600° C.

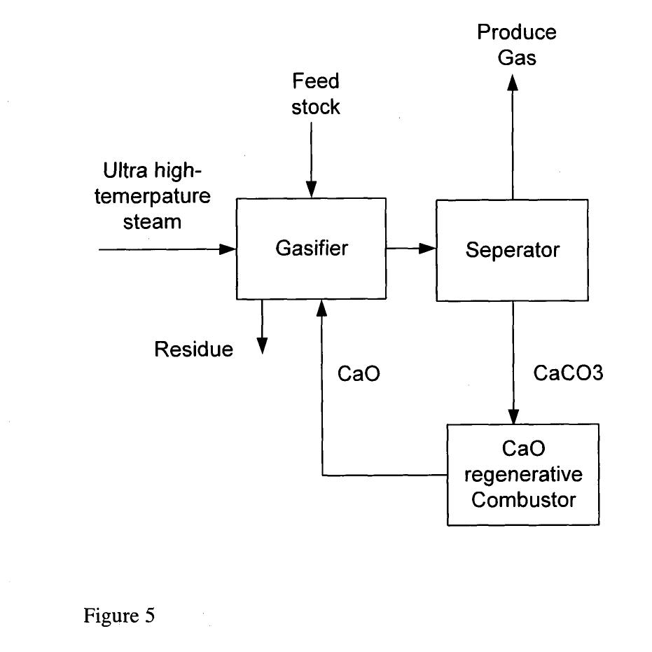

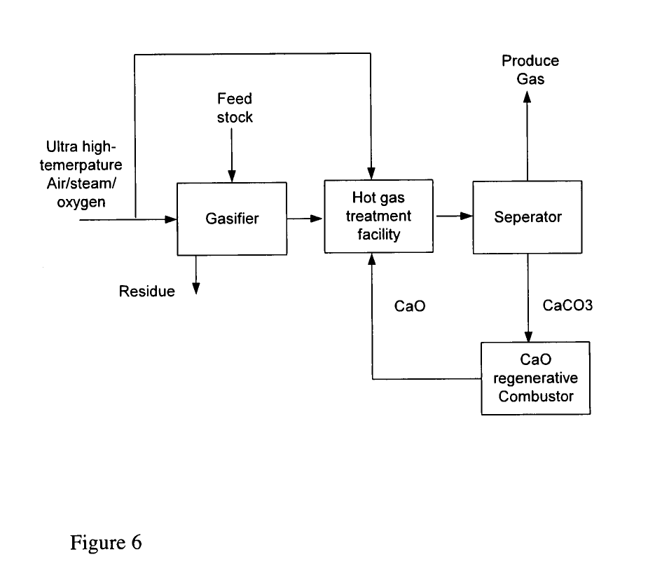

The gasification apparatus 1 can comprise:
A gasifier 24 with Ca-Based CO₂ sorbents (FIG. 5), or
A gasifier 24 and a hot syngas treatment facility gasifier or reformer 25 with a Ca-Based CO₂ sorbent (FIG. 6),

The advantages of the disclosed invention are:
Much less feedstock 2 needs to be burnt to supply the necessary energy compared to prior techniques. This is because sensible energy is provided to the process with the highly preheated agent 19 or 20, and heat released by the chemical reaction between calcined lime and carbon dioxide. The process can thus be run with a lower oxidant to fuel ratio which leads to lower concentrations of diluents such as CO₂ and N₂ in the product gas and thus a higher heating value.
High heating promotes the steam reforming reactions CₓH_{y}+xH₂O→xCO+(x+y/2)H₂ and the formation of light gases in the thermal decomposition of the feedstock 2.
Enhanced heat transfer causes shorter residence time of the biomass 2 in the gasification process.
A system less sensitive to the variability in particle size, heating value, and moisture content typically found in biomass feedstock.
The gasifier system 1 can be built extremely compact at even atmospheric pressure, lowering component costs.
Medium and High LCV value of syngas.
High content of hydrogen in the syngas.
Higher gas yields.
Lower tar contents.
Lower soot and char residues.

It is to be understood that the invention is not limited in its application to the details of construction and to the arrangements of the components set forth in the following description or illustrated in the drawings. The scope of the invention comprises embodiments and other ways of practicing and carrying out the invention. Also, it is to be understood that the phraseology and terminology employed herein are for the purpose of the description and should not be regarded as limiting.

Referring now again to the figures, FIG. 1 is a generalized flow diagram illustrating a preferred arrangement of the first type of embodiment of a solid fuel gasifying system according to the invention. A gasification facility includes a high temperature gasifying agent generator 18, a gasifier 24, optionally a shift reactor (reformer 25, not shown), a gas-solid separator or cyclone 26, and a regenerative combustor or calciner 27.

The high temperature gasifying agent generator 18 heats high temperature gases, such as air 3, steam 5, oxygen 6, exhaust gas, or a combination of them 7, to a temperature in the range of 800° C.-1600° C. This generator 18 comprises three components: a heat exchanger 21, a combustor 23, and a mixer 22, which can be used either alone or in any combination thereof. A high temperature gas (steam/air/oxygen) 20 is obtained from a low temperature gas 7, which passes through this heat exchanger 21. When this heat exchanger 21 is a normal metal heat exchanger, the temperature after the heat exchanger is around 300-500° C. When a regenerative heat exchanger is used, this temperature can be in the range of 800-1200° C. In order to achieve a higher temperature, an additional burner/combustor 23 is used. The exhaust gas temperature can be 2600° C. when an oxyfuel burner is used. Normally the temperature of this exhaust gas is around 1500-2000° C. In order to achieve a certain temperature for the gasifier 24, both hot streams, the one coming through the heat exchanger and the one coming from the combustor, will be mixed in a mixer 22. The temperature after the mixer is in the range of 800-1600° C.

When pure steam 5 is needed for the gasification process only the heat exchanger 21 is used. The temperature will be in the range of 600-1200° C.

The hot stream coming from the mixer 22 is then charged into the gasification apparatus 1 and specifically into a gasifier 24 and optionally a shift reactor or reformer 25. There will be two technical solutions depending on the gasification agents in this invention: One is where pure steam 5 is used as gasification agent, and another is where a steam/air/oxygen mixture 7 is used.

In the case when CaO 14 is mixed with feedstocks 2 only one gasification reactor is required. Here, the gasifier 24 and the shift reactor or reformer 25 (see example in FIG. 6) are integrated into one reactor. The main amount of pure steam 5 that is used for the gasification of solid fuel maybe as simply as:

CₙHₘ+H₂O→nCO+(n+m/2)H₂ (1)

The water-shift reaction is often used in order to get a high H₂ contents in the produced syngas:

CO+H₂O→CO₂+H₂−41.5 kJ/mol (2)

According to the disclosed invention the energy required for gasification process comes from:
1) Sensible heat carried by high temperature steam 19 (over 800° C.), and
2) Exothermic reaction of CO₂ absorption with a CaO sorbent 14:

CaO+CO₂→CaCO₃−178 kJ/mol (3).

The temperature of this reactor is maintained at 873-923 K (600-650° C.) to enable carbonization of CaO 14, i.e. to absorb CO₂ (not shown in figure). Simultaneously, the CO₂ partial pressure is reduced by CaO (eq3). This leads to an improvement of the hydrogen production in the produced gas 10, a syngas rich in hydrogen 11.

Since the equilibrium CO₂ partial pressure at 873 K is 0.004 atm over 90% of the CO₂ can be absorbed in the reactor 24, whose CO₂ partial pressure is approximately 20-40% if high temperature pure steam 19 is used. It should be noticed that Ca(OH)₂ formation does not occur in the absorber since the equilibrium pressure of H₂O of Ca(OH)₂ (eq 4) formation is higher than 1 atm at 873 K (600° C.).

CaO+H₂O->Ca(OH)₂ (4)

The produced CaCO₃ 15 is transported to the regenerator 27. Once there, the temperature is maintained at 1223K (950° C.). At this temperature, the equilibrium CO₂ partial pressure is 1.9 atm and the reverse reaction of equation (3) takes place even when the concentration of CO is over 90% at atmospheric pressure, as follows:

CaCO₃→CaO+CO₂ (5)

Since the calcination (Eq5) taking place in the combustor or calciner 27 is an endothermic reaction, the heat for the calcination of CaCO₃ 15 is supplied by the combustion of a part of the syngas, and of the char 17 from the gasifier 24.

In the case where CaO 14 is added into the gas clean system (FIG. 6) the gasification apparatus 1 comprises two reactors: one gasifier 24 and one shift reactor or reformer 25.

In the gasifier 24, the solid fuel 2 is thermally decomposed to produce the syngas 10 using the sensible heat of high temperature gasifying agent (steam/air/oxygen) 20 (600-1200° C.), and the heat generated by an exothermic oxidation reaction between the high temperature air 20 and solid fuel 2. The produced gas 13 comprises gases, such as CO, H₂, light and heavy hydrocarbons, and solid materials, such as tar. In particular, a larger excess of high temperature steam is generated.

The gasified gas and tar 13 containing the surplus of steam from the gasifier 24 then enter a reformer (not shown in FIG. 1), integrated in this case in the same reactor as the gasifier 24 with CaO 14 injection. This reformer is operated at 650° C. CO₂ is captured by CaO 14, and this promotes the water-shift reaction, and steam reforming reaction, thus a hydrogen-rich gas 11 is obtained. This reformed gas and CaCO₃ 15 pass a gas-solid separator 26. The spent Ca-based sorbents can be regenerated by calcination in the calciner 27 at high temperature (1173K (900° C.)). The calcined sorbents are supposed to be reused for CO₂ sorption in the reformer 25 (not shown). The heat for the calcination of CaCO₃ 15 is supplied by combustion of a part of syngas and char 17.

In this system, the water-gas shift reaction can take place in a mild temperature (approximately 973K (700° C.)) since the CO₂ is absorbed by the carbonation reaction, thus a low CO₂ partial pressure can promote the water shift reaction. Simultaneously, this results in the substantial increase in H₂ yield in the product gas 11.

FIG. 2 is a general side view of a gasifying agent generator 18 to heat a low temperature gas (steam/air/oxygen) 7 up to 1000° C. using a ball type regenerator which is representative of the gasifying agent generator 18 useful in the practice of the invention. The generator comprises two chambers 30 and 31. In each chamber, there is a normally a burner in the upper part of the chamber, while in the ball type regenerator it is located at the bottom of the combustion chamber. The system runs in two models. For example, when the burner 32 (left) starts to work, the hot exhaust gas generated by combustion at 1200-1400° C. passes through the void spaces between the regenerative balls 33. This hot exhaust gas is cooled down to a temperature as low as 200° C. The heat carried by the hot exhaust is stored in the regenerative balls 33. At a certain time, say 50-100 s, the burner 32 (left) is shut down, and a low temperature saturated steam/air/oxygen) 7 is fed from the bottom of the regenerative balls. This low temperature gas is heated up to 900-1300° when it passes through the regenerative balls 33. The preheated gas temperature can be 100-300° C. lower than that of the regenerative balls 33, say 800-1000° C. This hot stream 20 leaves the heat exchanger from the top of the chamber. In order to obtain a continuous high temperature stream, two chambers are integrated. When the left chamber serves as a combustion chamber the right chamber 31 works as a heat exchanging chamber.

Heat storage and heat release in the regenerators 18 are repeated periodically when combustion gas 9 and low temperature gas 7 are alternately provided by on-off action of a switching valve 34 located on the low temperature side. The preheated gas 20 continuously discharges from an exit nozzle 35 at the right hand side section, and combustion gas exhaust 28 from the left hand side section as shown in the figure.

FIG. 3 is a general side view of another type of gasifying agent generator 18 to heat a low temperature gas (steam/air/) 5 up to 1300° C. using a rotary honeycomb type regenerator which is representative of the gasifying agent generator 18 useful in the practice of the invention. The ultra-high temperature air/steam generator 18 comprises two chambers 36 and 37 and a rotary regenerative honeycomb heat exchanger 38. In this generator, only one is combustion chamber, and another, is a heat-exchanging chamber. In this drawing, the left chamber 36 is a combustion chamber. In the top of this chamber, a normal gas-burner is used to generate high temperature flue gas 28, which can be as high as 1500K (1223° C.) depending on the fuel and burner. This hot flue gas 28 passes though the rotary regenerator 38, the heat is stored in the regenerator and the temperature of flue gas 28 is cooled to around 120° C. when it leaves the system. The temperature of regenerator can be heated up to 1100-1300° C. Hot part regenerator is rotated to the other chamber 37 (see FIG. 3). Low temperature air and/or low temperature saturated steam 5 is injected into this hot regenerator, and is heated to a temperature only 50-80° C. lower than that of the regenerator. i.e., the temperature of air and/or steam 5 can be preheated up to 1250° C.

Heat storage and heat release in the regenerators are repeated periodically when combustion gas 9 and low temperature steam/air 7 are alternately provided by a rotary action, a continuous ultra-high temperature steam/air 19 can be obtained.

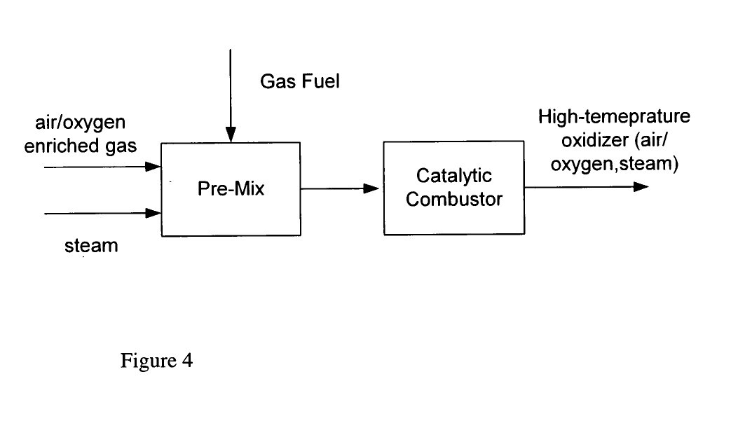

FIG. 4 is a general side view of another type of high temperature gasification agent generator 18 using a very lean catalytic combustor regenerator, which is representative of the regenerator useful in the practice of the invention.

A typical catalytic combustor working in very lean condition can also supply high temperature gas 20 for the gasification process 1.

Here, when normal gas fuel 9, for example LPG is used, an excess air ratio can be 3-6 when air is used as oxidizer. Here, we can generate a temperature of 0.900-1200° C. with the concentration of the mixture 7 as follows: 17.3% of O₂, 77.9% of N₂, 2.8% of H₂O (vapor) and 2.1% of CO₂, (the excess air ratio is 5). This can also be used for the gasification process 1.

In order to get a high content of steam in the exhaust gas, a hydrogen rich fuel 9/or pure hydrogen fuel can be used. For example the gas fuel 9 might enter a mixer 22 together with air/oxygen enriched gas 7 and pure steam 5 before passing to a catalytic combustor 23. The high-temperature oxidizer (air/oxygen/steam) might then be used in the gasifying process 1 as described as described below in FIG. 5.

FIG. 5 is a general block flow diagram of the gasification apparatus of the present invention. The system includes a gasifier 24, a gas-solid separator 26, and a combustor for regeneration of Ca-based sorbent 23. The feedstock 2 (solid fuel such as coal, biomass and/or waste), and Ca-based sorbent (CaO) 14, and ultra high temperature steam/air 19 are fed into a gasifier 24. The produced stream, gas and solid particles (tar, and CaCO₃) 13, enter a separator 26 for separation of gases and solids. The solid materials, which comprise mainly CaCO₃ 15, enter a reactor 23, and the thus spent Ca-based sorbents can be regenerated by calcination at high temperature such as 1273K.

FIG. 6 is a generalized block flow diagram illustrating a modification of the gasification apparatus 1 as shown in FIG. 5. A high temperature gasification agent 20 is fed into a gasifier 24, the thermal decomposition gas 13 from the solid fuel 2 flows into a hot gas treatment facility, together with/without high temperature steam 20. There, the gasified gas 13 and tar, containing much steam provided by the gasifier 24, enter a fluidized bed reformer 25 with CaO injection 14. This reformer 25 is operated at 650° C. CO₂ is captured by CaO 14, and this promotes the water-shift reaction, and steam reforming reaction, thus a hydrogen-rich gas 11 is obtained. This reformed gas 29 and CaCO₃ 15 pass a cyclone 26 or gas-solid separator. The spent Ca-based sorbents can be regenerated by calcination in a regenerative combustor 27 at high temperature (1173K (900° C.)). The calcined sorbents are supposed to be reused for CO₂ sorption in the reformer 25. The heat for the calcination of CaCO₃ 15 is supplied by combustion of a part of syngas.

FIG. 7 is a generalized block diagram of an exemplary gasification process 1 in accordance with an embodiment of the invention. A high temperature (900-1300° C.) gasification agent 19 is fed into a gasifier 24, and the thermal decomposition gas 13 from the solid fuel 2 flows into a hot gas treatment facility together with/without high temperature steam, the gasified gas and tar 13 containing much steam provided by the gasifier 24 enter a fluidized bed reformer 25 with CaO 14 injection. This reformer 25 is operated at 650° C. CO₂ is captured by CaO 14, and this promotes the water-shift reaction, and steam reforming reaction, thus a hydrogen-rich gas 11 is obtained. This reformed gas and CaCO₃ 15 pass a cyclone gas-solid separator 26. The spent Ca-based sorbents can be regenerated by calcination at high temperature (1173K). The calcined sorbents are supposed to be reused for CO₂ sorption in the reformer 25. Excess carbon dioxide 12 is released from the calciner. The heat for the calcination of CaCO₃ is supplied by combustion with air/O₂ 4 of a part of syngas.

FIG. 8 is another exemplary generalized block diagram of the total gasification process in accordance with an embodiment of the invention. The feedstock 2 (solid fuel such as coal, biomass and/or waste) first enters a mixer 16 and is mixed with the sorbent 14 (CaO), then, it is fed into a fixed bed reactor 24. An ultra-high temperature steam 19 (over 1200° C.) is generated by a gasifying agent generator 18, e.g. a regenerative heat exchanger, and flows into the bottom of the fixed bed reactor 24. The produced gas 13 enters a cyclone 26 to separate gas stream and solid materials. The solid materials, which mainly comprise CaCO₃ 15 enter a reactor 27, and this spent Ca-based sorbents 14 can be regenerated by calcination at high temperature according to:

CaCO₃→CaO+CO₂

Here the calcined sorbents are supposed to be reused for CO₂ sorption in the reformer 25. The heat for the calcination of CaCO₃ 15 is supplied by combustion with air/O₂ 4 of a part of syngas and of the char 17 from the gasifier. Excess carbon dioxide 12 is released from the calciner.

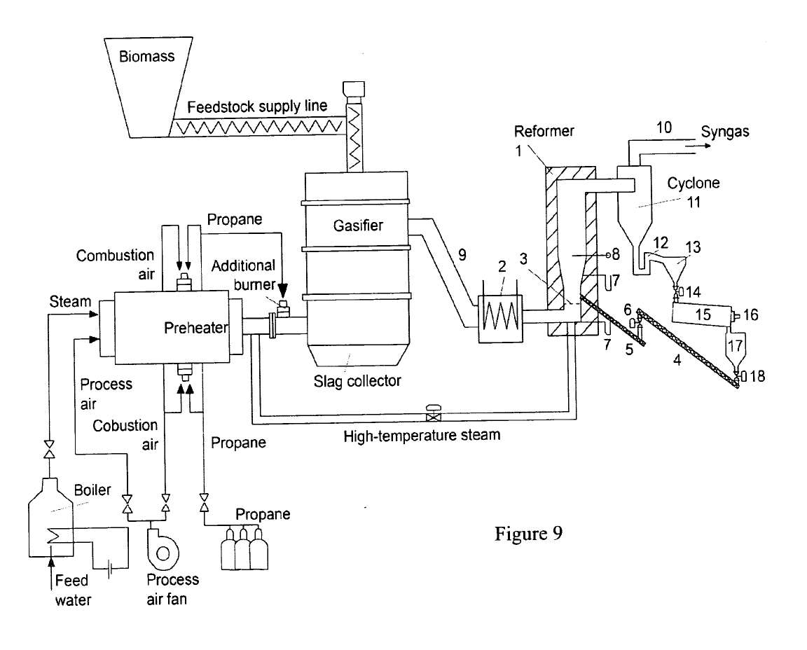

FIG. 9 is a generalized block diagram of an exemplary gasification facility in accordance with the invention, using a continuous counter-current updraft fixed-bed gasifier.

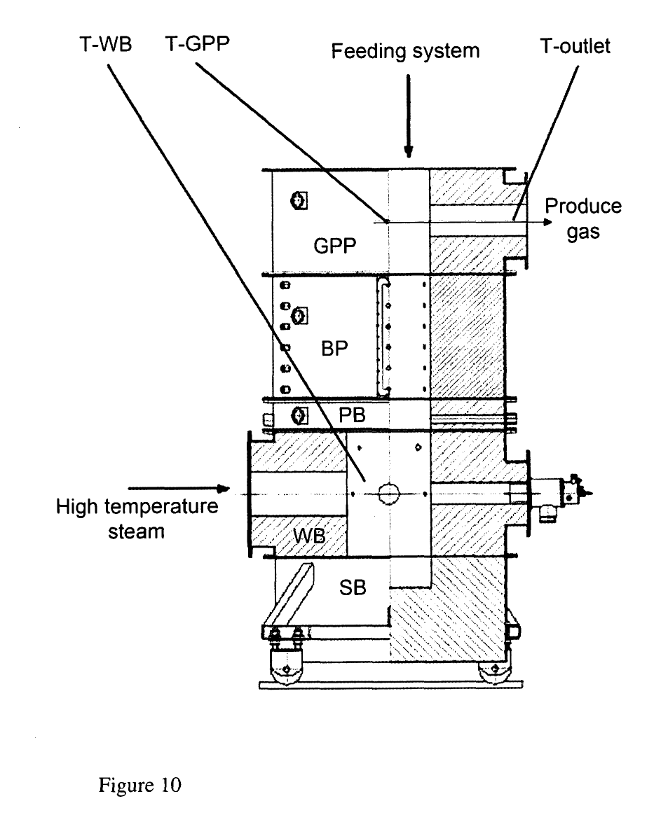

The fixed-bed gasifier 24 used in this example will be shown in detail in FIG. 10. A highly preheated air generator 18 is used to preheat air 3 or steam 5 up to 1200° C. This generator can be bought, for example, from Nippon Furnace CO. Ltd., Japan. An additional burner 39 for oxidizer temperature can further raise the temperature of steam/air 19 up to 1600° C. A fuel feeding system 40 consists of feedstock hopper, feeding screw, and two electric motors.

An electrical steam boiler 41 is used to produce slightly preheated steam 5 (180° C., 2.5 bar), equipped with a water preparation unit 42.

An air blower 44 is used to supply air 3 into pre-heater 18 and subsequently to the gasifier 24.

A fluidized bed reformer 25 is connected after the gasifier 24. In this reactor, the syngas 13 generated from the gasification system enters the bottom of the reactor. A gas distributor 45 is used. The limestone is injected above the distributor. The high-temperature steam 19 from high-temperature steam generator 18 can be injected depending on the quantity and the temperature of the steam in the syngas.

A cyclone 26 is used to separate the produced gas 29 from solid/particle including the CaCO₃. The cyclone 26 is temperature isolated to prevent condensed tars and water. Separated particles are stored in a container 46.

A kiln 27 is used for calcination of CaCO3. In order to regenerate the limestone, the temperature in the kiln should be higher than 900° C. Here, a normal gas burner 47, for example, a part of produce syngas is used to supply the heat to the process.

After regeneration of the sorbent, it is first stored in a chamber 48, and then transported by screw feeders 49 to the reformer 25. The fresh limestone can be added into this chamber 48 after several cycles of using. The quantity of Sorbents injecting to the reformer 25 is adjusted according to the measurements of CO₂ concentration/partial pressure and the temperature before 50 and after 51 the reformer 25.

The temperature in the reformer chamber 25 is one of the key parameters to control the steam reforming process based on the presence of CO₂ sorbents. The favorable operation temperature in the reformer 25 is in the range of 600-900° C. The Syngas 13 temperature from the outlet of the gasifier 24 can go up to 1200° C. since a high-temperature air/steam agent 19 is used. In this example, the temperature in the reformer 25 is monitored by thermocouple 52 and it can be adjusted by a heat exchanger 53.

For process control and safety reason pressure meters are installed 54.

The normal valves 55 are installed in the connecting places of the individual elements of the system. A siphon-trap 56 is installed between the cyclone 26 and the CaCO3 storage chamber 46.

FIG. 10 is an example of the updraft fixed bed gasifier 24 used in FIG. 9 with the temperature measurement points which are used for the gasifier control. It is a vertical cylindrical reactor which consists of six sections:
SB—slag box serving as slag collector
WB—wind box
PB—grate and pebble bed part
BP—bed part, feedstock (fixed bed) section
GPP—gas phase part, fuel gas outlet section
top—section of feedstock feeder

The high-temperature air/steam 19 is injected into the gasifier 24 from the left-bottom, and the feedstock (biomass 2) enters the gasifier 24 from the top of the gasifier. The produced gas 13 leaves the gasifier from the right top. The temperature of wind box T_WB, gas phase part of the gasifier T_GPP, and the produce gas 13 are monitored by the thermocouple 52 as shown in FIG. 9.

As to a further discussion of the manner of usage and operation of the present invention, this should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The illustrated embodiments of the invention will be best understood by reference to the drawings, wherein like parts are designated by like numerals throughout.

Reference Numerals: 1. Gasification apparatus or process; 2. Feedstock or Carbonaceous materials (coal, petroleum, coke, biomass, solid waste, solid fuel), 3. Air, 4. Air/Oxygen, combustion air. 5. Gasification agent comprising air/saturated steam or pure steam, 6. Combustion air, 7. Gasification agent comprising any combination of air, steam and oxygen, 8. Fuel (combustible), 9. Fuel and air or gas fuel, 10. Syngas, 11. Syngas rich in hydrogen, 12. Carbon Dioxide, 13. Gasified gas mixture, e.g. H2, CO, CO2, CH4 and N2), hydrocarbons. 14. Ca-based material such as CaO. 15. CaCO3, 16. Mixer of solid fuel, 17. Residue, Char from the gasifier, 18. Gasifying agent generator, 19. High or ultrahigh temperature steam, 20. High or ultrahigh temperature steam with additional components, 21. Heat exchanger, 22. Mixer, 23. Combustor, 24. Gasifier, up-draft reactor, fixed bed reactor, 25. Reformer, fluidized bed, or shift reactor, 26. Gas-solid Separator, Cyclone, 27. Calciner, regenerative combustor for generation of solvent, 28. Flue gases, 29. Reformed gas, 30. Chamber 1 of ball type generator, 31. Chamber 2 of ball type generator, 32. Burner of ball type generator, 33. Regenerative balls, 34. Switching valve, 35. Exit nozzle, 36. Chamber 1 of Honeycomb, 37. Chamber 2 of Honeycomb, 38. Rotatory regenerative Honeycomb heat exchanger, 39. Additional burner, 40. Fuel feeding system, 41. Electrical steam boiler, 42. Water preparation unit, 43. Feed water, 44. Air blower, 45. Gas distributor, 46. Container for storing separated particles, 47. Calciner's burner, 48. Storing chamber, 49. Screw feeders, 50. Temperature and CO₂ pressure before, 51. Temperature and CO₂ pressure after, 52. Thermocouple, 53. Heat exchanger between the gasifier and the reformer, 54. Pressure meters, 55. Normal valves, 56. Siphon-trap, 57. Slag collector.

### Example 1

### High-Temperature Air/Steam Gasification with Hot Gas Treatment Under the Presence of Ca-Based CO₂ Sorbents

One example of an embodiment of the invention is the high-temperature air/steam gasification with hot gas treatment under the presence of Ca-Based CO₂ sorbents.

A generalized block diagram of the gasification process is shown in FIG. 7. The apparatus used includes:
An updraft fixed bed gasifier 24. Here it is a cylinder manufactured by ceramic high-temperature materials with the work temperature up to 1500° C., for example, produced by Calderys Refractory Solutions Company. In this gasifier 24, high-temperature air/steam 20 is supplied from the gasifier bottom, and the feedstock 2 (biomass) is fed from the top of the gasifier 24.
A fluidized bed reformer 25
A cyclone 26 made by normal steel, and
A Calciner 27 equipped by a normal burner.

In the method of the invention, the following process occurs: a high temperature gasification agent 19 or 20 is fed into a gasifier 24, and the thermal decomposition gas 13 from the solid fuel 2 flows into a hot gas treatment facility 25, together with/without high-temperature steam. There the gasified gas and tar 13 containing much steam supplied by the gasifier 24 then enter a fluidized bed reformer 25 with CaO injection 14. This reformer 25 is operated at 700° C. at atmospheric pressure. CO₂ is captured by CaO 14, and this promotes the water-shift reaction, and steam reforming reaction, thus a hydrogen-rich gas 11 is obtained. This reformed gas 29 and CaCO₃ pass a cyclone 26 gas/solid separator. The spent Ca-based sorbents are regenerated by calcination in the calciner 27 at high temperature (1273K). The calcined sorbents are reused for CO₂ sorption in the reformer 25. The heat for the calcination of CaCO₃ 15 is supplied, for example, by combustion of a part of syngas.

More specifically, FIG. 9 is an exemplary high temperature air/steam gasification facility in accordance with an embodiment of the invention (see also FIG. 7). In this equipment, air 3 is supplied to the system by an air blower 43. Slightly preheated steam 5 (180° C., 2.5 bar) produced by an electrical steam boiler 41 is introduced to the air-line. The relative flow of the air 3 and steam 5 is regulated manually and monitored by a set of flow meters.

The temperature of the feed gas (air/steam mixture) is raised to over 1200° C. by a regenerative preheater 18 working in cycles in which the air/steam mixture passes through a hot honeycomb (see FIG. 3) in one chamber while hot combustion gases are heated up in another chamber with a subsequent inversion of the flow. To obtain temperatures of the air/steam mixture up to 1400-1600° C., additional fuel 8 (propane) is burned at the preheater outlet before the inlet to the reactor body in the presence of combustion air 4.

The gasifier body in this example is a vertical cylinder with an inner diameter of 0.4 m and consists of five sections from bottom to top organized as shown in FIG. 10.

The materials used in this example are;
Wood pellet is used as feedstock. The sizes of wood pellets are in the range of 6-12 mm.
The temperature of steam and air is 1273K, and the ratio of steam to carbon is 1-2.
The size of limestone used in the gas conditioning, CaO is in the range 300-400 μm. CaO absorbs 90% of CO₂ in the syngas at 700° C. and atmospheric pressure.

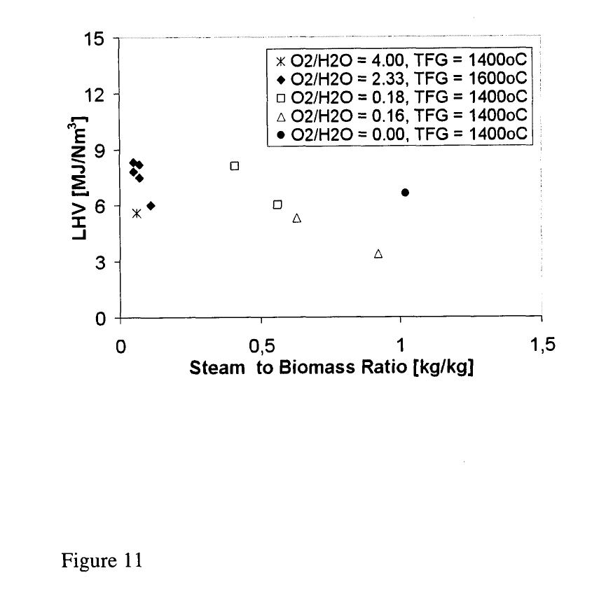

After the high-temperature air/steam gasifier 24 (FIG. 9) the following data are obtained: The syngas gas with LHVs of 7-9 MJ/Nm³ is produced via the disclosed invention using highly preheated air 19 as feed gas from biomass 2 (example in FIG. 11).

The concentration of H₂ in the product gas increases in response to increasing feed gas temperatures, in particular if steam is added to the feed gas. In fact, hydrogen concentrations, as high as 25-30%, are obtained from air/steam-HiTAG of wood pellets in the laboratory test.

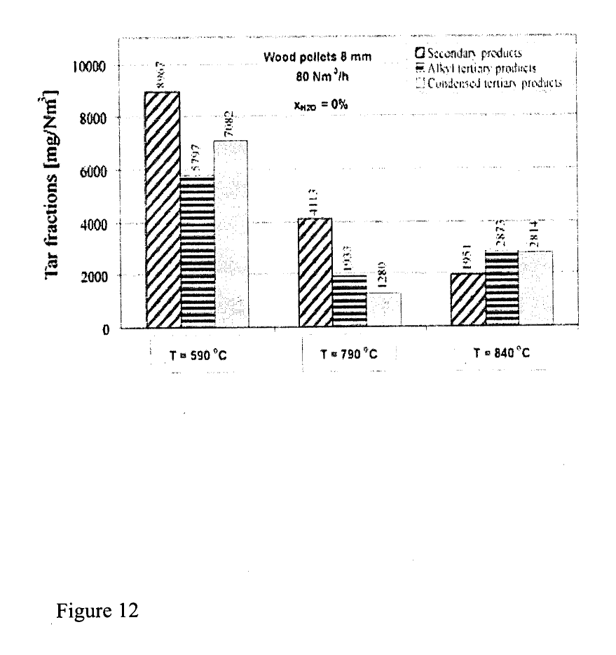

Solid phase adsorption (SPA) is used to characterize the tar in the product gas from HiTAG gasification and preliminary results indicate decreasing tar amounts in response to increasing feed gas temperatures (FIG. 12). Small scale experiments also show that (in the presence of O₂ in low concentrations) the product gas yield gains with respect to both solid and liquid yield when the temperature of the feed gas is increased to HiTAG levels.

After coupling of HiTAG gasifier with hot gas treatment, 90% of CO₂ is removed at atmospheric pressure, and tar is further eliminated. The hydrogen concentration is in the range of 40-80%, and the HHV is in the range of 12-16 MJ/Nm³.

### Example 2

### Biomass Gasification Using High-Temperature Air/Steam and Ca-Based CO₂ Sorbents

One example of an embodiment of the invention is biomass gasification using high-temperature air/steam and Ca-Based CO₂ sorbents. A generalized block diagram of the gasification process is shown in FIG. 8. The apparatuses used are:
An updraft fixed bed gasifier 24. Here it is a cylinder manufactured by a ceramic high-temperature material with the work temperature up to 1500° C., for example, produced by Calderys Refractory Solutions Company. In this gasifier 24, high-temperature air/steam 19 is supplied from the gasifier bottom, and the feedstock 2 (biomass) is fed from the top of the gasifier 24.
A steam heater 18. It is made by a regenerative honeycomb heat exchanged as shown in FIG. 3 or FIG. 9. After passing a saturated steam 5 through the heat exchanger, the temperature of steam achieves 1200° C. generated by
A mixer 16 for the mixing of feedstock and limestone
A cyclone 26 made by normal steel, and
A Calciner 27 equipped by a normal burner.

In the method of the invention, the following process is occurring: The feedstock 2 (solid fuel such as coal, biomass and waste) first enters a mixer 16 and is mixed with the sorbents 14 (CaO). Then it is fed into a fixed bed reactor 24. An ultra-high temperature steam 19 (over 1200° C.) is generated by a gasifying agent regenerator 18, such as a regenerative heat exchanger, and flows into the bottom of the fixed bed reactor 24. The produced gas 13 enters a cyclone 26 to separate gas streams and solid materials. The solid materials, mainly CaCO₃ 15, enter a reactor 27 (calciner), and this spent Ca-based sorbents 14 are regenerated by calcination at high temperature as:

CaCO₃→CaO+CO₂

The calcined sorbents are reused for CO₂ sorption in the reformer. The heat for the calcination of CaCO₃ is supplied by combusting a part of syngas.

The gasifier body is a vertical cylinder with an inner diameter of 0.4 m and a height of 0.75 m.

The materials used in this example are;
Wood pellet 2, which is a blend with limestone. The sizes of wood pellets are in the range of 6-12 mm.
Pure steam 5 with the temperature of 1173 K is used.
The size of limestone, CaO 14, for the gas conditioning is in the range 300-400 μm. CaO absorbs 90% of CO₂ in the syngas in the range of 1173° C. at atmospheric pressure.
The mass balances in the thermal gasification system in FIG. 8 are calculated using a computer program in order to estimate the steady state equilibrium. Wood pellets are used, and the cellulose is assumed to have a general chemical formula CH_{1.5}O_{0.638}.

The estimated results show that 90% of CO₂ is removed at atmospheric pressure, and tar is further very small, and there is no need for further treatment. The hydrogen concentration is in the range of 60-90%, and the HHV is in the range of 16-20 MJ/Nm³.

1. A method for gasifying a solid material, comprising:
a) providing at least one high heat source to supply energy for gasification in a gasifier containing the solid material, resulting in gases including CO₂ and hydrogen gas, and particulates, the heat source provided by a method selected from the group consisting of:
i) feeding a high temperature gasifying agent to supply heat into the gasifier; and/or
ii) utilizing a Ca-based CO₂ absorbent to supply exothermic reaction heat;
b) separating syngas from the particulates in a separator; and
c) recovering the Ca-based CO, absorbent by a heating step,
wherein the gasifier is at atmospheric pressure, and wherein complete gasification is increased in the gasifier.

2. The method of claim 1, wherein the solid material is selected from the group consisting of coal, petroleum coke, biomass, and solid waste.

3. The method of claim 1, wherein the Ca-based CO₂ absorbent is CaO.

4. The method of claim 3, wherein the CaO is added to the gasifier together with the solid material and the high temperature gasifying agent, and the gasifier is at 600-900° C.

5. The method of claim 3, wherein the CaO is added to a refining process of the produced gas for capturing the formed carbon dioxide in a second reactor, and the temperature of the second reactor is at 600-900° C.

6. The method of claim 1, wherein the high temperature gasifying agent is selected from the group consisting of steam, air and oxygen and combinations thereof.

7. The method of claim 6, wherein the high temperature gasifying agent is pure steam, and a single gasification reactor is used to produce a high level of hydrogen gas.

8. The method of claim 6, wherein the high temperature gasifying agent is a mixture of components selected from the group consisting of steam, air and oxygen, and the gasification utilizes two reactors, a first reactor to thermally decompose solid fuel to produce gases, solid materials and excess steam, and a second reactor to produce a hydrogen-rich gas.

9. A gasification apparatus comprising: a) a high temperature gasifying agent generator, b) a gasifier, c) a solid gas separator, and d) a combustor for regeneration of sorbent.

10. The gasification apparatus of claim 9, wherein the high temperature gasifying agent generator comprises at least one of: a heat exchanger, a combustor and a mixer, to generate a high temperature gas with a temperature in the range of 800 to 1600° C.

11. The gasification apparatus of claim 9, wherein the gasifying agent is selected from the group consisting of steam, air, oxygen, exhaust gas, and the combination thereof.

12. The gasification apparatus of claim 9, wherein the gasification apparatus is a gasifier with a Ca-based CO₂ sorbent.

13. The gasification apparatus of claim 9, wherein the gasification apparatus is a gasifier and a hot syngas treatment facility gasifier with a Ca-based CO₂ sorbent.

14. The gasification apparatus of claim 9, wherein the high temperature gasifying agent generator comprises an exchanger selected from the group consisting of a ball type regenerator, a rotary honeycomb type generator, and a catalytic combustor regenerator.

15. The gasification apparatus of claim 9, wherein the apparatus gasifier is a continuous counter-current updraft fixed bed gasifier, the high temperature gasifying agent is preheated by a preheated air generator, and the apparatus further comprises a cyclone is used to separate produced gas from solid material, and a kiln for calcination of CaCO₃.
